(19) United States
(12) Patent Application Publication
(10) Pub. No.: US 2007/0212130 A1
(43) Pub. Date: Sep. 13, 2007

(54) Image forming apparatus

(75) Inventors: Akitomo Kuwabara, Ibaraki (JP); Takeshi Terakado, Ibaraki (JP); Hidenori Iwanaga, Ibaraki (JP); Akihiro Takayama, Ibaraki (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: RICOH PRINTING SYSTEMS, LTD., Tokyo (JP)

(21) Appl. No.: 11/656,538

(22) Filed: Jan. 23, 2007

(30) Foreign Application Priority Data
Jan. 25, 2006 (JP) P2006-016457

(51) Int. Cl. G03G 15/16

(52) U.S. Cl. 399/316

(57) ABSTRACT

According to an embodiment of the invention, there is provided an image forming apparatus including: a photosensitive member; a toner image forming unit forming a toner image on a surface of the photosensitive member; a transfer unit transferring the toner image formed on the surface of the photosensitive member to a recording medium; a first transport unit transporting the recording medium through between the photosensitive member and the transfer unit; a second transport unit transporting the recording medium which passes through between the photosensitive member and the transfer unit to a subsequent stage; a guide unit being disposed on an upstream and downstream sides of a transporting direction of the recording medium with respect to the transfer unit, the guide unit guiding the recording medium by being contact with or away from the surface of photosensitive member; a pressing unit pressing the recording medium against the photosensitive member; a first driving unit driving the guide unit so as to make the recording medium being contact with or away from the photosensitive member; and a second driving unit driving the pressing unit so as to make the recording medium being contact with or away from the surface of the photosensitive member.

### CROSS-REFERENCE TO RELATED APPLICATIONS

This application is based on and claims the benefit of priority from the prior Japanese Patent Application No. 2006-016457, filed on Jan. 25, 2006; the entire contents of which are incorporated herein by reference.

### BACKGROUND

1. Technical Field

The present invention relates to an electrophotographic image forming apparatus, and more particularly, relates to an image forming apparatus capable of forming a good quality image free from image defects even when the image is formed on a rough paper sheet or a paper sheet wrinkled by heat.

2. Description of Related Art

A continuous feed printer is often used for computer output printing on a document form. However, in recent years, taking advantage of the function as high speed variable information printing, it has come to be used for multi-purpose printing of direct mails, bills, manuals, books, and the like. With the increasing ranges of uses thereof, there arises a necessity for the continuous feed printer to be adaptable to, from thin paper to thick paper, in terms of the webs to be used, and various webs of from wood-free paper to rough paper sheets in terms of the web type.

On the other hand, from the viewpoint of conservation of natural resources, there are growing needs to carry out double-side printing in the following manner. Two continuous feed printers are used, and operated in tandem. Thus, the first side is printed by the first printer. Then, the web side is reversed, so that the second side is printed by the second printer. For responding to such multi-purpose uses, the transfer performance of a transfer unit becomes particularly important in order to obtain the image quality free from image defects.

However, generally, in the case of tandem printing, the web is damaged by heat during the fixing by the first printer, so that unevenness by thermal shrinkage occurs. Therefore, at the transfer part of the second printer, the adhesion between the web and the photosensitive drum surface is inferior. Accordingly, unfavorably, image defects due to poor transfer tend to occur in the concave region in the web surface.

FIG. 10 is a conceptual drawing of a tandem printing system capable of double-side printing of continuous form paper, which includes a first continuous feed printer P1 for forming an image 30a on a first side of a web 14, and a second continuous feed printer P2 for forming an image 30b on a second side.

The continuous feed printers P1 and P2 transport perforated box paper or unperforated roll paper at high speed (0.5 to 2 m/sec), and perform printing. Distinct from cut paper, the web 14 has no cut in the web, and forms a continuous web.

The continuous web 14 undergoes printing of the image 30a thereon by the first printer P1 having an image forming part of a photosensitive member 1a, a developing machine 21a, and the like. Then, the web 14 is reversed by a turn bar T. Further, the image 30b is printed on the back side with the second printer P2 having an image forming part of a photosensitive member 1b, a developing machine 21b, and the like.

When images are printed on the opposite sides of the web 14 in this manner, for example, when an image is formed by the second printer on the back side of the web portion which stopped in the B part region including a fixing part for fixing the first image 30a on the web 14, image defects unfavorably occur.

FIG. 11 is a schematic view showing how the web stops at the fixing part in the B part on an enlarged scale. The fixing part is formed of a preheater 25 for bringing the web 14 in contact therewith as shown, and preheating it, a heat roll 26 mounting a heater therein, and a backup roll 27 for applying a pressure onto the heat roll 26.

The fixing part continues to feed heat to the web 14 during continuous printing. It stops feeding heat upon stop of printing. However, immediately after stop of printing, the response is bad, and hence overshoot occurs. As a result, the web 14 on the preheater 25 thermally shrinks in the direction of an arrow in the drawing, or unevenness occurs due to thermal damage in the web. For this reason, when printing is restarted, and the web portion which stopped on the preheater 25 of the first printer P1 passes through the image forming part of the second printer P2, image defects become more likely to occur.

FIG. 12 is a schematic view showing how the toner is transferred at the transfer part of the second printer P2. A toner image 29 formed on the photosensitive member 1b has a positive polarity, and it is electrostatically adsorbed on the photosensitive member 1b. Thus, by the corona discharge from a corona transfer unit 3, the web 14 becomes negatively charged, so that the toner image 29 is transferred onto the web 14 side. However, when the web 14 is deformed in a concave shape by heat like a C part in the drawing, the toner is left on the photosensitive member 1b without being transferred. For this reason, a phenomenon referred to as void occurs.

In order to solve such a problem, there has been conventionally known a method in which a transfer assist blade is provided to press the web against a surface of the photosensitive member. FIG. 7 shows a configuration in which a transfer assist blade 8 is adopted for the transfer part. On the upstream side of the corona transfer unit 3 as seen from the web transport direction, there is disposed the transfer assist blade 8 formed of a plate or film made of plastic, a metal plate, or the like. Incidentally, in the same drawing, a reference numeral 2 represents a transfer part housing; 7, a lower separator; and 16, a paper guide.

By the transfer assist blade 8, the web 14 is pressed against the surface of the photosensitive drum 1. When the web 14 being in contact therewith reaches the position opposite to the corona transfer unit 3, it receives electric charges from the corona transfer unit 3, which causes the toner image 29 to be transferred onto the web 14. Further, the web 14 is fed to a fixing apparatus (not shown) by a web transport device. By disposing the transfer assist blade 8 in this manner, it becomes possible to reduce the gap between the uneven spot in the surface of the web 14 and the photosensitive drum 1. As a result, favorable transfer can be obtained.

However, in the case of double-side printing, when the toner image 30b is printed on the second side of the web 14, the toner image 30a has already been formed on the first side. Thus, as the side, to be in contact with the transfer assist blade 8, of the web 14 to be transported to the transfer part housing 2, the first side having the toner image 30a formed thereon comes. For this reason, the surface of the fixed toner image 30a is rubbed by the transfer assist blade 8. Thus, a portion of the toner is deposited on the transfer assist blade 8, and becomes stain. This causes deterioration of the image 30a formed on the first side.

In general, at the time of printing for forming an image on the second side of the web 14, the deformation of the web 14 has occurred under the heat history during the fixing process during printing of the first side. Therefore, in order to improve the adhesion, the pressing pressure of the transfer assist blade 8 is required to be more increased. This causes a problem that the blade stain is increasingly promoted.

On the other hand, as previously described, a continuous feed printer is also required to be adaptable to various webs in order to respond to multi-purposes. The width of each web to be used is also used properly according to the intended purpose. For example, when a long (21- to 22-inch) photosensitive drum is used, the width of the web is also as diverse as 12 inches, 16 inches, or 22 inches. The web has a width of 12 to 16 inches for business forms. For printing of manuals, books, and the like, the web is cut after printing. Therefore, the web has a width of 17 inches capable of providing two A4-sized sheets, or 22 inches capable of providing three B5-sized sheets. For this reason, for printing a narrow width web, unless the transfer assist blade 8 with a length at least equal to or less than the web width is used, the photosensitive drum 1 is damaged by contact therewith, resulting in deterioration of printing quality.

In order to solve such a problem, JP-A-9-171308 discloses a system in which a plurality of transfer assist blades are provided, and the transfer assist blades are used in combination according to the web width.

However, although this system can respond to a given web width, the constitution becomes complicated. Thus, unfavorably, the transfer assist mechanism becomes large-sized, and expensive.

In order to solve the problems, there is also proposed a system using a transfer assist roller as shown in FIG. 8. This has the following structure. A transfer assist roller 17 made of a roller covered with a rubber or the like is provided on the upstream side of the corona transfer unit 3 as seen from the web transport direction. The transfer assist roller 17 is connected with a high voltage power source 18, and pressed against a photosensitive drum 1 side by a spring 31. Thus, it is rotated in a driven manner with respect to running of the web 14.

By the transfer assist roller 17, the web 14 reaches the position opposite to the corona transfer unit 3 while being in contact with the photosensitive member 1. Thus, it receives electric charges from the corona transfer unit 3, and transfers the toner image thereon. Then, it is fed to a fixing apparatus (not shown) by the web transport device.

With such a structure, the transfer assist roller 17 is rotated in a driven manner with respect to the web 14. Therefore, as compared with the case where the transfer assist blade is used, the stain of the web 14 is reduced.

Further, the transfer assist roller 17 does not also damage the photosensitive drum 1, and hence it can also be used for the web having a given width. However, when a narrow width web is printed, a portion of the transfer assist roller 17 comes in direct contact with the photosensitive drum 1. Therefore, the slight toner deposited on the photosensitive member 1 is deposited on the transfer assist roller 17. In order to avoid the foregoing, the following measure is taken. By the use of a high voltage power source 18, electric charges of the opposite polarity to that of the toner are applied to the core of the transfer assist roller 17. This, however, entails a problem of an increase in cost.

### SUMMARY

It is an object of the present invention to provide an image forming apparatus which has solved the foregoing problems in the related art. Specifically, it is an object of the invention to provide an image forming apparatus capable of forming good quality image at a low cost also on rough paper sheets, webs which have undergone thermal deformation, or various webs having different widths without causing image defects, and without causing blade stain.

According to an aspect of the invention, there is provided an image forming apparatus comprising: a photosensitive member; a toner image forming unit forming a toner image on a surface of the photosensitive member; a transfer unit transferring the toner image formed on the surface of the photosensitive member to a recording medium; a first transport unit transporting the recording medium through between the photosensitive member and the transfer unit; a second transport unit transporting the recording medium which passes through between the photosensitive member and the transfer unit to a subsequent stage; a guide unit being disposed on an upstream and downstream sides of a transporting direction of the recording medium with respect to the transfer unit, the guide unit guiding the recording medium by being contact with or away from the surface of photosensitive member; a pressing unit pressing the recording medium against the photosensitive member; a first driving unit driving the guide unit so as to make the recording medium being contact with or away from the photosensitive member; and a second driving unit driving the pressing unit so as to make the recording medium being contact with or away from the surface of the photosensitive member.

According to another aspect of the invention, the pressing unit comprises; a first pressing member extending in a direction which is substantially perpendicular to the transporting direction of the recording medium and capable of pressing the recording medium against a direction of the surface of the photosensitive member; and a second pressing member capable of independently pressing the recording medium on the direction of the surface of the photosensitive member from the first pressing member.

According to another aspect of the invention, the first and second pressing members have step parts overlapping with each other.

According to another aspect of the invention, there is provide an image forming apparatus including: a mask member movable in accordance with a width of the recording medium for printing with respect to in the direction which is substantially perpendicular to the transporting direction of the recording medium, wherein the mask member prevents the second pressing member from pressing the recording medium on the direction of the surface of the photosensitive member

According to another aspect of the invention, the pressing member is selectively driven by the second driving unit in accordance with a state or kind of the recording medium transported by the first transport unit.

### BRIEF DESCRIPTION OF THE DRAWINGS

FIG. 1 is a configuration view showing a transfer part in an image forming apparatus according to an embodiment of the invention;

FIG. 2 is a schematic configuration view illustrating the operation of the transfer part in the image forming apparatus according to the embodiment;

FIG. 3 is a schematic configuration view illustrating the operation of the transfer part in the image forming apparatus according to the embodiment;

FIG. 4 is a top view showing a configuration of a transfer assist blade in the transfer part according to the embodiment;

FIG. 5 is a front view in the transfer part of the apparatus according to the embodiment;

FIG. 6 is a cross sectional view in the transfer part of the apparatus according to the embodiment;

FIG. 7 is a schematic view showing a configuration of a transfer part having a transfer assist blade according to a relate art;

FIG. 8 is a schematic view showing a configuration of a transfer part having a transfer assist roller according to the related art;

FIG. 9 is a schematic configuration view showing an overall apparatus configuration of the image forming apparatus according to the embodiment;

FIG. 10 is an explanatory view of tandem printing;

FIG. 11 is an explanatory view showing the state of a web which has stopped on a fixing unit upon stop of printing; and

FIG. 12 is an explanatory view showing the state of voids.

### DESCRIPTION OF THE EMBODIMENTS

A whole configuration of an image forming apparatus in accordance with an embodiment of the invention will be described. The configuration and operation of a transfer assist blade will be described in this order.

(1) Overall Apparatus Configuration

FIG. 9 is an overall configuration view showing one example of the image forming apparatus according the embodiment of the invention. In the same drawing, along the rotating circumferential surface of the photosensitive member 1, there are disposed a charger 19, an exposing device 20, a developing machine 21, and a corona transfer unit 3. The surface of the photosensitive member 1 uniformly receives electric charges by the charger 19. Then, a laser light is applied onto the surface of the photosensitive member 1 according to image data by the exposing device 20. As a result, an electrostatic latent image is formed on the surface of the photosensitive member 1, and developed by the developing machine 21. Thus, a toner image is formed on the surface of the photosensitive member 1.

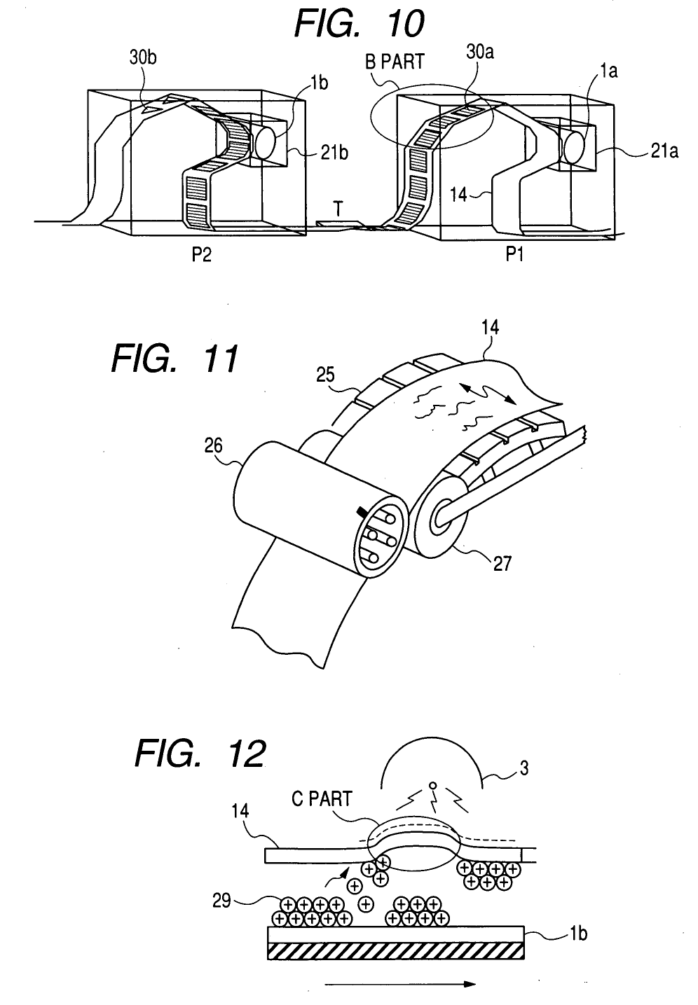

On the other hand, the web 14 is transported to a transfer part by the web transport devices 22, 23, and 24. Then, by the corona transfer unit 3, the toner image is transferred on the web 14. The toner image on the web 14 is heated to the vicinity of the transition temperature of the toner resin when it passes through a preheater 25. Then, by a fixing machine 35 formed of a heat roller 26 including a heater therein, and a backup roller 27, the toner image is molten and fixed on the web 14. Incidentally, when double-side printing is carried out, two image forming apparatuses are used in the same manner as in FIG. 10.

(2) Configuration of Transfer Part 40

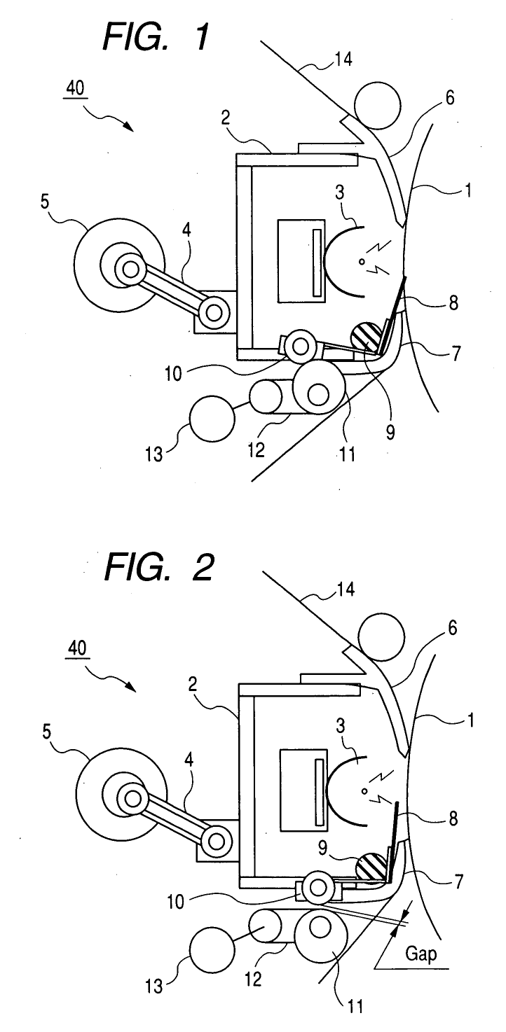

FIG. 1 shows a configuration of the transfer part in the image forming apparatus according to the embodiment. A reference numeral 1 represents a photosensitive drum. In the example, a selenium photosensitive member, or a plus charged photosensitive member such as plus OPC or a-Si is used. The development method of the photosensitive drum 1 is a reversal development method, and the polarity of the charge of the toner is a plus polarity.

The transfer part 40 includes a transfer unit housing 2, a transfer assist blade 8 disposed in an inside thereof, and a negatively charged corona transfer unit 3. The transfer assist blade 8 is formed of a substantially plate or sheet made of plastic, a metal plate, or the like. In the example, the transfer assist blade 8 is formed by using Mylar sheet such as Kapton, and the thickness is set to be about 0.1 to 1.0 mm. The transfer assist blade 8 is at the position in the vicinity of the corona transfer unit 3. It does not cut off the corona discharge from the corona transfer unit 3, and is disposed between the upper separator 6 and the lower separator 7 guiding the web 14. Thus, it is in a positional relation such that the web 14 and the photosensitive drum are pressed against one another in the nip region.

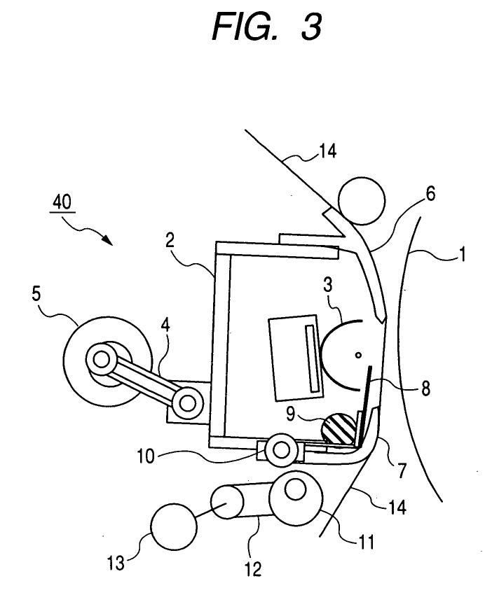

A reference numeral 5 represents a driving motor, of which the rotation power is transferred to the transfer unit housing 2 connected via a link 4. Namely, when the driving motor 5 rotates, the transfer housing 2 rotationally moves about the rotation center of the drawing. When the transfer housing 2 rotationally moves, under the guide of the upper separator 6 and the lower separator 7 attached to the transfer unit housing 2, the web 14 moves from the state apart from the surface of the photosensitive drum 1 (FIG. 3) to the state in contact with the photosensitive drum 1 (FIG. 2).

On the other hand, the transfer assist blade 8 is supported by a hinge shaft 9 attached to the lower separator 7. To the tip portion of the hinge shaft 9, a cam follower 10 fixed to the transfer housing 2 is attached. A cam 11 is disposed at the position in the vicinity of the cam follower 10, and the cam 11 is connected to a motor 13 via a timing belt 12.

Then, the operation of the transfer part 40 constituted as described above will be described.

(3) Operation of Transfer Part 40

FIG. 3 shows the state of the transfer part during printing standby. The photosensitive drum 1 and the web 14 are in a non-contact state. Whereas, the cam 11 and the cam follower 10 are also in a non-contact state. When the web 14 is fed to the transfer part 40 by a web transport device (not shown), and the preparation of the printing operation is completed, the driving motor 5 rotates. Then, the transfer unit housing 2 rotationally moves from the position of FIG. 3 to a point at a prescribed distance from the surface of the photosensitive drum 1 about the rotation center position as the center. When the transfer unit housing 2 rotationally moves, the upper separator 6 and the lower separator 7 attached to the transfer unit housing 2 also rotationally moves. As a result, the web 14 also moves to a position in the vicinity of the surface of the photosensitive drum 1.

FIG. 2 shows the state in which the web 14 has come in contact with the surface of the photosensitive drum 1, and the printing operation by the transfer part 40 has become possible. For general printing, i.e., when the web 14 has not been damaged by heat, the transfer part 40 can perform printing in the state of FIG. 2. Thus, the transfer assist blade 8 is not required to be operated. For the transfer assist blade 8, the cam 11 is at the rotational movement position at the top dead center in the state of FIG. 2. Therefore, the surfaces of the cam follower 10 and the cam 11 are in a state apart from each other, so that the transfer assist blade 8 is in a non-operation state.

Then, a description will be given to the case where the transfer assist blade 8 is operated as in the case where the region of the web 14 which stopped on the preheater 25 of the first printer (for surface side printing) passes through the transfer part of the second printer (for back side printing).

In this case, the cam 11 connected to the motor 13 via the timing belt 12 is rotationally moved to the position of the bottom dead center shown in FIG. 1. When the cam 11 comes to the position of the bottom dead center, the surfaces of the cam 11 and the cam follower 10 come in contact with each other. This causes the cam follower 10 to rotationally move. Therefore, the transfer assist blade 8 also rotationally moves about the hinge shaft 9 as the center. As a result, as shown in FIG. 1, the transfer assist blade 8 presses the web 14 against the surface of the photosensitive drum 1. Therefore, for example, even when the web 14 has been thermally damaged, and unevenness has occurred in the surface, the web 14 comes in close contact with the surface of the photosensitive drum 1 due to the pressing operation of the transfer assist blade 8. This allows favorable transfer to be carried out.

Incidentally, in the foregoing example, the timing for pressing the transfer assist blade 8 against the surface of the photosensitive drum 1, and the pressing time are determined in the following manner.

In the tandem printer system, when the path length of the web 14 between on the preheater 25 of the first printer and the transfer part of the second printer is, for example, 110 inches, and the web transport speed is 30 inches/sec, the time required for the web on the preheater 25 to run into the transfer part of the second printer from the start of printing is about 3.6 s. Therefore, the timing and time of operation of the transfer assist blade 8 are determined allowing for around about ±1 S.

The path length between the first printer and the second printer is large, and may vary. Therefore, a certain degree of margin is required to be allowed. In this case, even when the operation timing is slightly fast, a large trouble does not occur. Further, it is configured such that the retraction driving system of the transfer assist blade 8 is not mounted in the transfer unit housing 2, but disposed in another frame. Therefore, it becomes possible to minimize the weight of the transfer unit housing 2 including the upper separator 6 and the lower separator 7. Accordingly, it becomes possible to suppress the image deterioration upon emergency stop or upon start.

In the embodiment of the invention described up to this point, as the driving source for the retracting operation of the transfer assist blade, the motor 13 is used. However, the driving source may also be a solenoid or the like. Whereas, in the example, it is configured such that the web 14 comes in contact with the surface of the photosensitive drum 1 at the position of the bottom dead center of the cam 11. However, by adjusting the position of rotational movement of the cam 11 for contact with the web 14, it is possible to adjust the magnitude of the pressing force. Namely, for the basis weights of various webs, the position at which the cam 11 stops is adjusted. This enables a proper pressing force to be set according to the basis weight of the web.

(4) Configuration of transfer assist blade 8

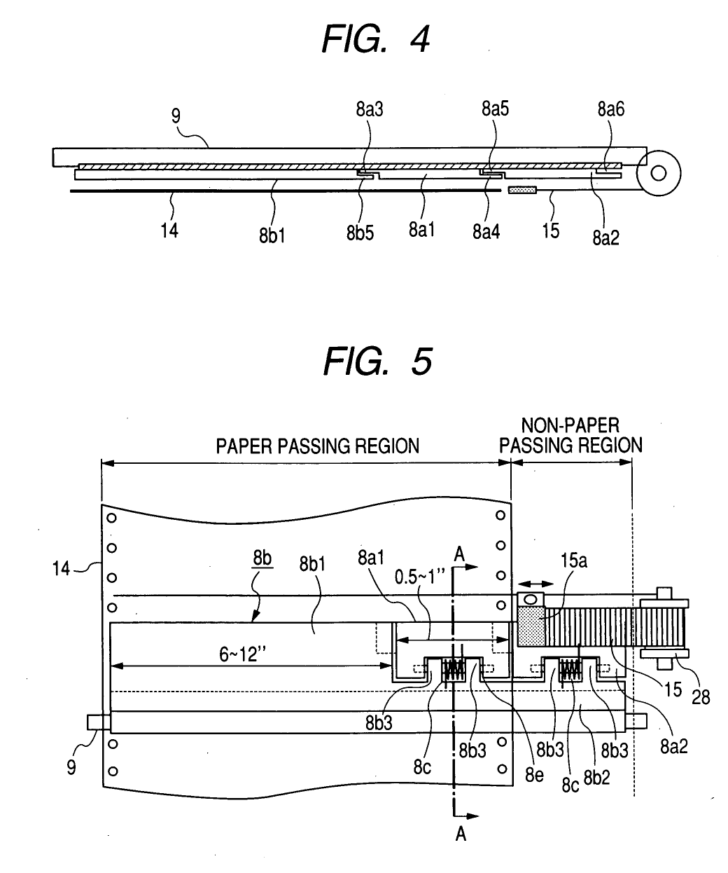

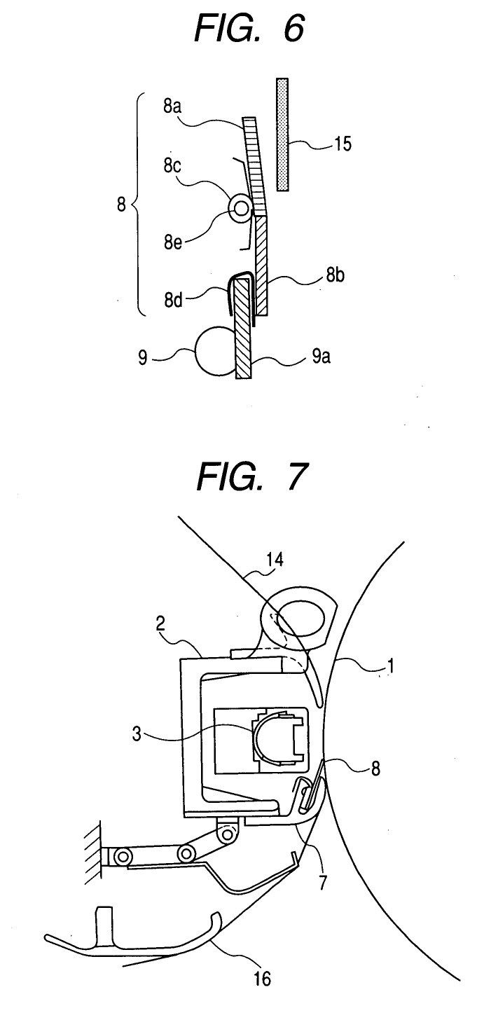

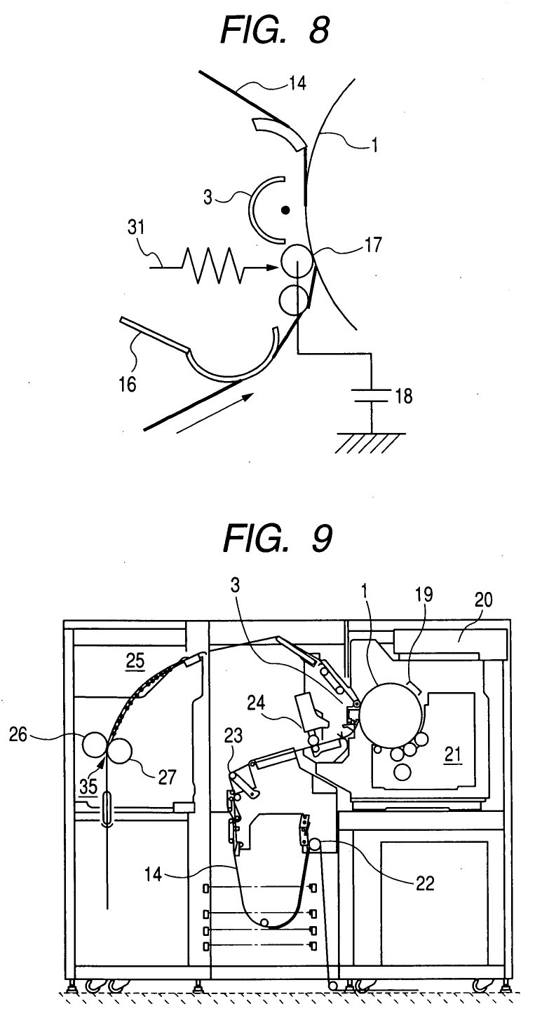

Next, the configuration of the inventive transfer assist blade 8 adaptable to various web widths will be described by reference to FIG. 4, FIG. 5, and FIG. 6. FIG. 4 is a top view, FIG. 5 is a front view, and FIG. 6 shows a cross section along A-A part.

As shown in FIG. 6, the transfer assist blade 8 in accordance with the embodiment is formed of a movable side assist blade 8a, a fixed side assist blade 8b, a spring 8c, a lane holder 8d, and a shaft 8e.

The fixed side assist blade 8 extends in the direction orthogonal to the direction of transport of the web 14 as shown in FIG. 5. It has a portion 8b1 long in the direction of transport of the web, and a portion 8b2 short in the direction of transport. At the short portion 8b2, a plurality of convex portions 8b3 are formed as shown. Through the convex portions 8, a shaft 8e penetrates. To the shaft 8e, the movable side assist blade 8a and the spring 8c are attached. It is configured such that the movable side assist blade 8a imposes its load on the photosensitive drum 1 side by the spring 8c. The spring constant of the spring 8cis set so as to be equal to the spring constant of the fixed side assist blade 8. This is for making the pressure load on the photosensitive drum 1 by the transfer assist blade 8 uniform in the direction of width of the web 14. A plurality of the movable side assist blades 8a are mounted according to each apparatus size. In this example, there is shown an example in which two blades 8a1 and 8a2 are disposed.

Incidentally, as shown in FIG. 4, in the fixed side assist blade 8b1, a step part 8b5 is provided, and formed in such a manner as to overlap a step part 8a3 of the movable side assist blade 8a1. Whereas, another step part 8a4 of the movable side assist blade 8a1 is formed in such a manner as to overlap a step part 8a5 of the movable side assist blade 8a2. These steps have a role of a stopper toward the photosensitive drum 1 side.

The fixed side assist blade 8 and the movable side assist blade 8a are manufactured with a plate or film made of plastic, a plate made of a metal, or the like. In this example, the length of the portion 8b1 of the fixed side assist blade 8 is set at 6 to 12 inches, and the length of the movable side assist blade 8a is set at 0.5 to 1 inch.

The fixed side assist blade 8b is, as shown in FIG. 6, fixed at a rail holder 8d for holding a guide rail 9a. By fixing the fixed side assist blade 8 to the rail holder 8d, changing of the transfer assist blade 8 becomes easy. Further, when the hinge shaft 9 rotates, the transfer assist blade 8 also rotates about the hinge shaft 9 as the center.

On the other hand, as shown in FIG. 5, a corotron mask 15 is disposed between the photosensitive drum 1 and the movable transfer assist blade 8a2. The corotron mask 15 is wound on a reel 28 disposed outside the region where the web 14 is transported. It is configured such that the edge 15a can move in the direction of an arrow according to the width of the web 14. The corotron mask 15 serves as a shield between the transfer unit 3 (FIGS. 1 to 3) and the photosensitive drum 1 in a non paper passing region. Thus, it prevents the corona discharge therebetween, and thereby achieves the protection of the photosensitive drum 1 in the non paper passing region.

Then, the operation of the transfer assist blade 8 will be described.

(5) Operation of transfer assist blade 8

Now, the case where a narrow width web 14 as shown in FIG. 5 is used will be considered. When the cam 11 is present at the position of FIG. 2, the fixed side assist blade 8 is present at a position away from the web 14 and the photosensitive drum 1. At this time, the movable side assist blades 8a1 and 8a2 impose the loads on the photosensitive drum 1 side by the spring 8c. However, they are inhibited from moving toward the photosensitive drum 1 side by the step parts 8a3 to 8a5.

Then, the motor 13 is driven, and the cam 11 rotationally moves, and comes to the position of FIG. 1, the hinge shaft 9 also rotationally moves. Accordingly, the fixed side assist blade 8b also rotationally moves in the direction in which the web 14 is pressed against the photosensitive drum 1 side. The movable side assist blade 8a1 also rotationally moves in the direction in which the web 14 is pressed against the photosensitive drum 1 side by the spring 8c.

On the other hand, a pressing force toward the photosensitive drum 1 side also acts on the movable side assist blade 8a2 by the spring 8c. However, by the corotron mask 15 disposed thereabove, the rotational movement is inhibited, resulting in no contact with the surface of the photosensitive drum 1. Namely, the transfer assist blade 8 is pressed against the photosensitive drum 1 side only in the paper passing region of the web 14, and does not come in contact with the photosensitive drum 1 in the non paper passing region. Therefore, it does not damage the surface. Further, the corona discharge of the transfer unit 3 in the non paper passing region is shielded by the corotron mask 15.

Then, when a wide width web 14 is used, the edge 15a of the corotron mask 15 moves in the right direction of FIG. 5 according to the width of the web 14. Therefore, when the hinge shaft 9 rotationally moves, the fixed side assist blade 8 also rotationally moves, and the two movable side assist blades 8a1 and 8a2 also rotationally move. Thus, the transfer assist blade 8 operates in such a manner as to press the whole width region of the web 14 against the photosensitive drum 1 side.

Thus, in accordance with the example, the number of the rotationally moving movable side assist blades 8a changes according to the width of the web 14. This can prevent the transfer assist blade from coming in contact with the portion of the photosensitive drum 1 in the non paper passing region. Incidentally, in the example, a description is given to the example in which two movable side assist blades 8aare disposed in the direction of width of the web 14. However, an increase in the number enables the printer to be adaptable to various web widths.

(1) Even when a rough paper sheet having a large unevenness on the surface is used, favorable transfer free from image defects becomes possible.

(2) In the case where double-side printing is performed by a tandem printing apparatus using a corona transfer system, even when a web undergoes thermal deformation by the first printer, it becomes possible to prevent voids in the image during transfer at the second printer. This can reduce image defects.

(3) It is configured such that the driving unit for the transfer assist blade and the driving unit for the web guide unit of the transfer part are separately operated. For this reason, for example, it becomes possible to bring only the web portion which stopped at the fixing part of the first printer into contact with the surface of the photosensitive drum by the transfer assist blade. Therefore, it is possible to minimize rubbing of the image side by the transfer assist blade. Thus, by limiting the pressing operation of the transfer assist blade only to the necessary time, the life of the transfer assist blade or the photosensitive drum elongates, and the stain of the web due to the transfer assist blade can also be minimized.

(4) Driving of the transfer assist blade and driving of the web guide unit are separated, and separately operating driving sources therefor are adopted. Therefore, it becomes possible to adjust the pressing force applied on the web to the optimum magnitude according to the basis amount of the web.

(5) The transfer assist blade is configured to be divided into sections in the direction of width of the web, and the number of the sections to be driven is changed according to the web width. This enables the printer to be adaptable to various web widths. With such a configuration, various transfer assist blades are not required to be disposed. Therefore, maintenance of the transfer assist blade and the changing operation of the transfer assist blade become very easy.

What is claimed is:

1. An image forming apparatus comprising:
a photosensitive member;
a toner image forming unit forming a toner image on a surface of the photosensitive member;
a transfer unit transferring the toner image formed on the surface of the photosensitive member to a recording medium;
a first transport unit transporting the recording medium through between the photosensitive member and the transfer unit;
a second transport unit transporting the recording medium which passes through between the photosensitive member and the transfer unit to a subsequent stage;
a guide unit being disposed on an upstream and downstream sides of a transporting direction of the recording medium with respect to the transfer unit, the guide unit guiding the recording medium by being contact with or away from the surface of photosensitive member;
a pressing unit pressing the recording medium against the photosensitive member;
a first driving unit driving the guide unit so as to make the recording medium being contact with or away from the photosensitive member; and
a second driving unit driving the pressing unit so as to make the recording medium being contact with or away from the surface of the photosensitive member.

2. The image forming apparatus according to claim 1, wherein the pressing unit comprises;
a first pressing member extending in a direction which is substantially perpendicular to the transporting direction of the recording medium and capable of pressing the recording medium against a direction of the surface of the photosensitive member; and
a second pressing member capable of independently pressing the recording medium on the direction of the surface of the photosensitive member from the first pressing member.

3. The image forming apparatus according to any one of claim 2, wherein the first and second pressing members have step parts overlapping with each other.

4. The image forming apparatus according to claim 2, comprising: a mask member movable in accordance with a width of the recording medium for printing with respect to in the direction which is substantially perpendicular to the transporting direction of the recording medium, wherein the mask member prevents the second pressing member from pressing the recording medium on the direction of the surface of the photosensitive member

5. The image forming apparatus according to claim 1, wherein the pressing member is selectively driven by the second driving unit in accordance with a state or kind of the recording medium transported by the first transport unit.
